(19) United States
(12) Patent Application Publication
(10) Pub. No.: US 2026/0044981 A1
(43) Pub. Date: Feb. 12, 2026

(54) INFORMATION PROCESSING APPARATUS AND INFORMATION PROCESSING METHOD

(71) Applicant: CANON KABUSHIKI KAISHA, Tokyo (JP)

(72) Inventors: SHUNSUKE TSUDA, Tokyo (JP); HIROMI KINEBUCHI, Kanagawa (JP)

(21) Appl. No.: 19/275,809

(22) Filed: Jul. 21, 2025

(30) Foreign Application Priority Data
Aug. 7, 2024 (JP) 2024-130995

(51) Int. Cl. G06T 7/73

(52) U.S. Cl. CPC G06T 7/73; G06T 2207/10132

(57) ABSTRACT

One or more information processing apparatuses, one or more information processing methods, and one or more storage mediums are provided herein. At least one embodiment of an information processing apparatus includes an acquisition unit that operates to acquire a captured image of an ultrasound probe, a position estimation unit that operates to estimate the positions of a plurality of virtual feature points preset on a surface of the ultrasound probe based on the image acquired by the acquisition unit, and an orientation estimation unit that operates to estimate an orientation of the ultrasound probe based on the positions of the plurality of virtual feature points estimated by the position estimation unit.

### BACKGROUND

### Field of the Technology

The present disclosure relates to one or more embodiments of an information processing apparatus and an information processing method.

### Description of the Related Art

In an examination using an ultrasonic diagnostic apparatus, the ultrasound image of the inside of a subject may be obtained by applying an ultrasound probe, which is an examination device, to a subject from the body surface of the subject. To identify which region of the subject has been examined during the examination, a technique is known for sensing the space coordinates of the examination device as the examination device scans the subject.

In the technique described in Japanese Patent Laid-Open No. 2020-127629, the position and orientation of an ultrasound probe is detected by a camera and a human-shaped marker attached to an examination device.

The technique described in Japanese Patent Laid-Open No. 2019-136273 uses a magnetic sensor, an acceleration sensor, or the like to detect the position and orientation of an ultrasound probe.

However, when using the camera and the marker described in Japanese Patent Laid-Open No. 2020-127629, it is difficult to estimate the orientation in a situation where the marker is hidden by another object, that is, occlusion occurs. In addition, if an additional sensor, such as a magnetic sensor, is installed to solve the occlusion issue, as disclosed in Japanese Patent Laid-Open No. 2019-136273, the configuration of the ultrasound probe becomes more complex.

### SUMMARY

The present disclosure provides at least one embodiment of an information processing apparatus that operates to accurately estimate an orientation of an examination device without providing a sensor in the examination device.

According to at least one aspect of the present disclosure, there is provided at least one embodiment of an information processing apparatus including an acquisition unit that operates to acquire a captured image of an examination device, a position estimation unit that operates to estimate positions of a plurality of virtual feature points preset on a surface of the examination device based on the image acquired by the acquisition unit, and an orientation estimation unit that operates to estimate an orientation of the examination device based on the positions of the plurality of virtual feature points estimated by the position estimation unit.

According to other aspects of the present disclosure, one or more additional information processing apparatuses, one or more information processing methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration that may be used for one or more embodiments of an ultrasonic diagnostic apparatus in accordance with the present disclosure.

FIG. 2 illustrates an installation configuration that may be used for one or more embodiments of an ultrasonic diagnostic apparatus in accordance with the present disclosure.

FIG. 3 is a flowchart of at least one embodiment of a process flow of a position and orientation estimation in accordance with the present disclosure.

FIG. 4 illustrates virtual feature points of one or more embodiments of an ultrasound probe in accordance with the present disclosure.

FIG. 5 illustrates training data for one or more embodiments of a deep learning model in accordance with the present disclosure.

FIG. 6 illustrates at least one embodiment example of a result of estimating the coordinates of a virtual feature point in accordance with the present disclosure.

FIG. 7 illustrates at least one embodiment example of a result of estimating the coordinates of a virtual feature point in accordance with the present disclosure.

FIG. 8 illustrates at least one embodiment example of a configuration that may be used for an ultrasound probe in accordance with the present disclosure.

FIG. 9 illustrates at least one embodiment example of a displayed diagnostic ultrasound image in accordance with the present disclosure.

FIG. 10 illustrates at least one embodiment example of a configuration that may be used for an ultrasound probe in accordance with the present disclosure.

FIG. 11 is at least one embodiment of a flowchart of a process flow of position and orientation estimation in accordance with the present disclosure.

FIG. 12 is at least one embodiment of a flowchart of an automatic identification flow of an ultrasound probe in accordance with the present disclosure.

### DESCRIPTION OF THE EMBODIMENTS

One or more embodiments of the present disclosure are described in detail below. Details of One or More Embodiments

One or more embodiments are described below. According to one or more embodiments, an example of an ultrasonic diagnostic apparatus serving as a medical diagnostic imaging apparatus is described. The ultrasonic diagnostic apparatus may include an ultrasonic diagnostic apparatus main body serving as an information processing apparatus.

### Configuration of One or More Embodiments of an Ultrasonic Diagnostic Apparatus

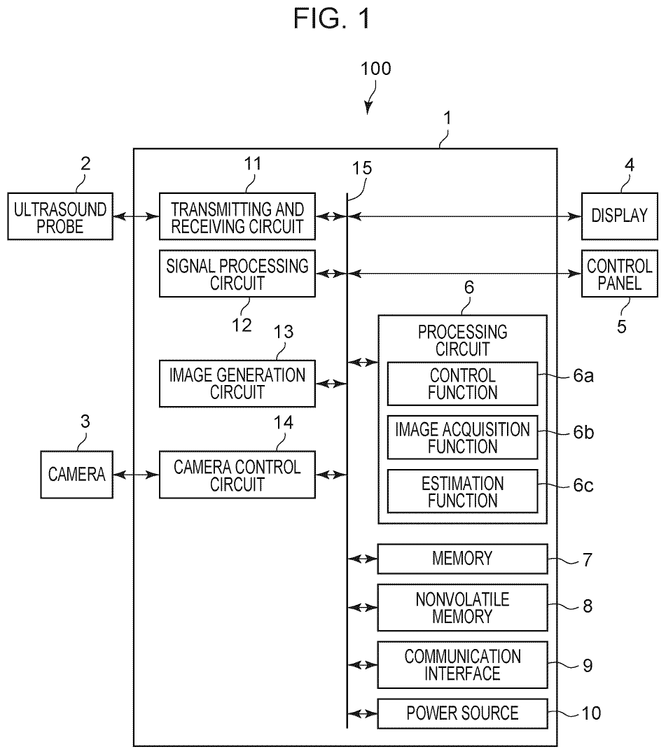

FIG. 1 is a block diagram of at least one embodiment example configuration of an ultrasonic diagnostic apparatus 100 serving as a medical diagnostic imaging apparatus in accordance with the present disclosure. As illustrated in FIG. 1, the ultrasonic diagnostic apparatus 100 includes an ultrasonic diagnostic apparatus main body 1 serving as an information processing apparatus, an ultrasound probe 2 serving as an examination device, a camera 3 serving as an image capture unit, a display 4 serving as a display unit, and a control panel 5 serving as an instruction unit. The ultrasonic diagnostic apparatus main body 1 serving as the information processing apparatus includes a computer equipped with a variety of control units, a power source, and a communication interface inside the chassis thereof.

The ultrasonic diagnostic apparatus main body 1 includes a transmitting and receiving circuit 11, a signal processing circuit 12, an image generation circuit 13, a camera control circuit 14, a processing circuit 6, a memory 7, a nonvolatile memory 8 serving as a storage medium, a communication interface 9, and a power source 10, each connected to an internal bus 15.

All the configurations connected to the internal bus 15 are configured or operate to be able to exchange data with one another via the internal bus 15.

### One or More Embodiments of an Ultrasound Probe

The ultrasound probe 2 is an example of an examination device that may be used in one or more embodiments in accordance with the present disclosure. The ultrasound probe 2 transmits and receives ultrasonic waves with the surface of the pointed tip thereof in contact with the surface of a subject A. The ultrasound probe 2 includes a plurality of piezoelectric transducers and is connected to the ultrasonic diagnostic apparatus main body 1. The ultrasound probe 2 generates ultrasonic waves in the plurality of piezoelectric transducers on the basis of a control signal supplied from the ultrasonic diagnostic apparatus main body 1, receives the reflected waves from the subject A, and converts the reflected waves into electrical signals (echo signals).

The ultrasound probe 2 may be an ultrasound probe of any type, such as a sector ultrasound probe, a linear ultrasound probe, or a convex ultrasound probe. The ultrasound probe 2 may be a one-dimensional ultrasound probe with a plurality of piezoelectric transducers arranged in a row. Alternatively, the ultrasound probe 2 may be an ultrasound probe in which a plurality of piezoelectric transducers of a one-dimensional ultrasound probe mechanically shake. Still alternatively, the ultrasound probe 2 may be a two-dimensional ultrasound probe with a plurality of piezoelectric transducers arranged in a grid in two dimensions.

### One or More Embodiments of a Camera

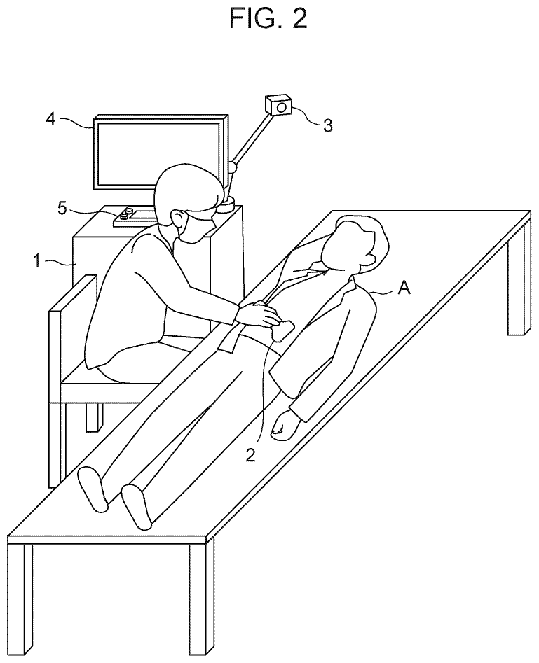

FIG. 2 illustrates at least one embodiment example of an installation configuration of the ultrasonic diagnostic apparatus main body 1, the ultrasound probe 2, the camera 3, the display 4, and the control panel 5 that may be used. According to one or more embodiments, the camera 3 is mainly used to acquire an exterior image for identifying an examination region of the subject A during examination using the ultrasound probe 2. More specifically, the camera 3 captures an exterior image including the examination region and the ultrasound probe 2 during examination of the subject A using the ultrasound probe 2. The camera 3 may be installed, for example, at an end of an arm provided on the ultrasonic diagnostic apparatus main body 1 and may be used to capture the image of the surroundings of the ultrasonic diagnostic apparatus 100. Alternatively, the camera 3 may be installed so as to be separated from the ultrasonic diagnostic apparatus main body 1 (for example, installed on the ceiling). The camera 3 may be installed at any location as long as the image of a photographic subject, that is, the ultrasound probe 2, may be captured.

In one or more embodiments, the camera 3 may have a configuration to function as a commonly used camera that includes an image pickup optical system, an image pickup element, a central processing unit (CPU), an image processing circuit, a read only memory (ROM), a random-access memory (RAM), and at least one communication interface (I/F). Light flux from a photographic subject is incident on an image pickup element (for example, a CCD or CMOS sensor) by the image pickup optical system including an optical element, such as a lens, to form an image. The image pickup optical system includes a lens group, and the camera 3 may include a lens drive control circuit that controls zooming and focusing by driving the lens group in the optical axis direction. An electrical signal output from the image pickup element is converted into digital image data by an A/D converter and, then, is subjected to various image processing operations in the image processing circuit, and is output to an external apparatus. At least a subset of the image processing operations to be performed by the image processing circuit may be performed by a processing circuit of the external apparatus after the digital image data is output to the external apparatus via the communication I/F.

According to one or more embodiments of the present disclosure, the camera 3 uses the image pickup element that mainly receives light in the visible light region. However, an example of the camera 3 is not limited thereto and may be a camera that receives light in the infrared light region or a camera that receives light in multiple wavelength regions, such as visible light and infrared light, and capture an image. Alternatively, the example of the camera 3 may be a stereo camera that enables distance measurement in addition to capturing an exterior image or a camera including a TOF (Time Of Flight) sensor for distance measurement. Hereafter, an image captured by the camera 3 is referred to as a “camera image”.

### One or More Embodiments of a Display Apparatus

The display 4 includes a display device, such as, but not limited to, a liquid crystal display (LCD). The display 4 displays, on the display device, an image, a menu screen, a graphical user interface (GUI), and the like input from the ultrasonic diagnostic apparatus main body 1. More specifically, the display 4 displays, on the display device, an image stored in the memory of the ultrasonic diagnostic apparatus main body 1 or an image stored in the nonvolatile memory of the ultrasonic diagnostic apparatus main body 1.

The display 4 also displays an ultrasound image, a camera image, a body mark image, a probe mark image, and the region identification result. As used herein, the term “body mark image” refers to an image simply representing the shape of the human body. A body mark image is commonly used in ultrasonic diagnostic apparatuses. The term “probe mark image” refers to a mark superimposed on the body mark image. A probe mark image is used to identify, at a glance, the angle at which the ultrasound probe 2 is in contact with the tangent plane to the human body.

### One or More Embodiments of a User Interface

The control panel 5 may be composed of a keyboard, a trackball, a switch, a dial, a touch panel, or the like. The control panel 5 accepts various input operations performed by an examiner using these control members (for example, an instruction for capturing an image using the ultrasound probe 2 or the camera 3, an instruction for displaying a variety of images, image switching, mode selection, or an instruction for various settings). An accepted input operation signal is input to the ultrasonic diagnostic apparatus main body 1 and is reflected in a variety of control operations. In a case where the control panel 5 is a touch panel, the control panel 5 may be integrated with the display 4, and the examiner may perform various settings and operations on the ultrasonic diagnostic apparatus main body 1 by touching or dragging a button displayed on the display 4.

When a signal is received from the ultrasound probe 2 and, thereafter, the ultrasound image in the memory of the ultrasonic diagnostic apparatus main body 1 is being updated and in a case where a freeze button is operated by the examiner, the signal from the ultrasound probe 2 is stopped and, thus, the updating of the ultrasound image in the memory is temporarily halted. At this time, the signal from the camera 3 may also be stopped, and the updating of the camera image in the memory may be temporarily halted.

For example, when the updating of the camera image in the memory has been halted and in a case where the freeze button is operated, a signal is received from the ultrasound probe 2 again, and the updating of the ultrasound image in the memory is started. In addition, the updating of the camera image is also started in the same way. In a case where the examiner operates an OK button in a case where one ultrasound image is determined by pressing the freeze button, the ultrasound image is stored in the nonvolatile memory. The freeze button and the OK button may be provided on the control panel 5 instead of on the ultrasound probe 2.

### One or More Embodiments of a Control Circuit

In one or more embodiments of the ultrasonic diagnostic apparatus 100, each of processing functions may be stored in the nonvolatile memory 8 serving as the storage medium in the form of a program executable by the computer. In one or more embodiments, the transmitting and receiving circuit 11, the signal processing circuit 12, the image generation circuit 13, the camera control circuit 14, and the processing circuit 6 are processors that read and execute the programs from the nonvolatile memory 8 to provide the functions corresponding to the programs. That is, each of the circuits that have read the programs has a function corresponding to one of the read-out programs.

As used herein, the term “processor” refers to a circuit such as a central processing unit (CPU) or a graphics processing unit (GPU). Alternatively, the term “processor” refers to a circuit, such as an application specific integrated circuit (ASIC), a programmable logic device (for example, a simple programmable logic device (SPLD) or a complex programmable logic device (CPLD)), or a field programmable gate array (FPGA). The processor reads and executes the program stored in the memory to provide a function. Instead of storing the program in the memory, the configuration may be such that the processor has the program directly embedded in circuitry thereof. In this case, the processor reads and executes the program embedded in the circuitry to provide the function. According to one or more embodiments, each of the processors is not limited to a processor configured as a single circuit, but may also be a single processor configured by combining a plurality of independent circuits to provide its function.

The memory 7 is, for example, a RAM (for example, a volatile memory using semiconductor devices).

The processing circuit 6 controls each of the configurations of the ultrasonic diagnostic apparatus main body 1 using the memory 7 as a work memory on the basis of a program stored in the nonvolatile memory 8. The processing circuit 6 has a control function 6a, an image acquisition function 6b, and an estimation function 6c. The control function 6a performs a variety of processes related to capturing of an ultrasound image and displaying of the ultrasound image. The image acquisition function 6b performs a variety of processes related to the acquisition of an image to be captured by the camera. The estimation function 6c estimates the position and orientation of the ultrasound probe 2 using the camera image.

The nonvolatile memory 8 stores image data, subject data, and a variety of programs for the circuits including the processing circuit 6 to operate. The nonvolatile memory 8 is composed of a hard disk (HD) or a ROM, for example.

The transmitting and receiving circuit 11 includes at least one communication interface to supply electric power to the ultrasound probe 2, transmit a control signal, and receive an echo signal or the like. The transmitting and receiving circuit 11 provides a control signal to cause the ultrasound probe 2 to emit an ultrasonic beam based on the control signal transmitted from the processing circuit 6, for example. Furthermore, the transmitting and receiving circuit 11 receives a reflected wave signal, or an echo signal, from the ultrasound probe 2, performs phase rectifying addition on the reception signal, and outputs a signal obtained by the phase rectifying addition to the signal processing circuit 12.

In one or more embodiments, the signal processing circuit 12 may include a B-mode processing circuit, a Doppler mode processing circuit, a color Doppler mode processing circuit, and/or the like. The B-mode processing circuit performs existing processing to generate an image based on the amplitude information of the reception signal supplied from the transmitting and receiving circuit 11 and generates B-mode signal data. The Doppler mode processing circuit performs existing processing to extract a Doppler shift frequency component from the reception signal supplied from the transmitting and receiving circuit 11 and performs FFT (Fast Fourier Transform) processing or the like to generate Doppler signal data of blood flow information. The color Doppler mode processing circuit performs existing processing to generate an image based on blood flow information from the reception signal supplied from the transmitting and receiving circuit 11 and generates color Doppler mode signal data. The signal processing circuit 12 outputs the generated variety of data to the image generation circuit 13.

The image generation circuit 13 generates two-dimensional and three-dimensional ultrasound images related to a scan area through existing processing on the basis of the data supplied from the signal processing circuit 12. For example, the image generation circuit 13 generates volume data related to the scan area from the supplied data. The image generation circuit 13 generates, from the generated volume data, two-dimensional ultrasound image data through MPR processing (a multi-planar reconstruction method) and three-dimensional ultrasound image data through volume rendering processing. Examples of an ultrasound image include a B-mode image, a Doppler mode image, a color Doppler mode images, and an M-mode image.

The camera control circuit 14 includes at least one communication interface to supply electric power to the camera 3, transmit and receive a control signal, and transmit and receive an image signal. The camera 3 may include a power source to operate by itself without receiving electric power from the ultrasonic diagnostic apparatus main body 1. The camera control circuit 14 may control a variety of image capture parameters (for example, zoom, focus, and F-number) of the camera 3 by transmitting a control signal to the camera 3 via the communication interface. The camera 3 may include an automatic pan-tiltable head and receive a pan-tilt control signal so as to be able to control the position and orientation by pan-tilt drive. The above is the description of at least one embodiment example of a configuration of the ultrasonic diagnostic apparatus 100 that may be used in accordance with the present disclosure. Under such a configuration, the position and orientation of the ultrasound probe 2 is estimated by the estimation function 6c on the basis of the image captured by the camera 3.

### One or More Embodiments of an Ultrasound Probe Position and Orientation Estimation

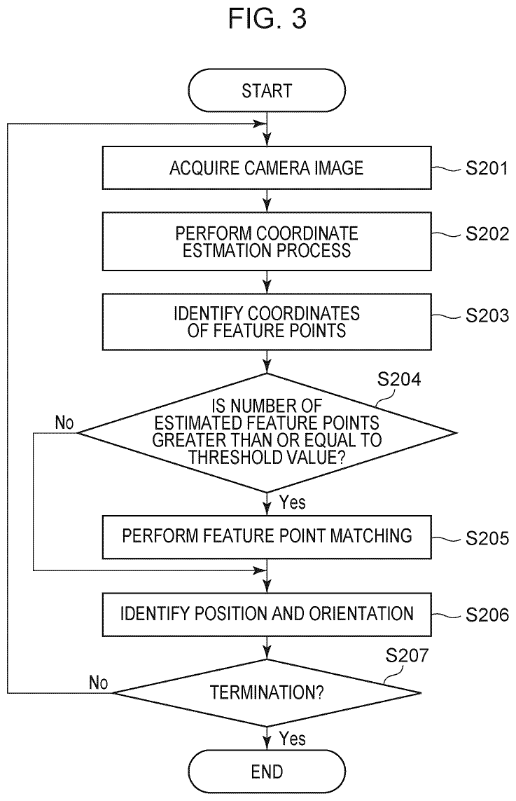

FIG. 3 is a flowchart of at least one embodiment example of a process of estimating the position and orientation of the ultrasound probe 2 performed by the estimation function 6c. A moving image captured by the camera is acquired at each of time points, and the ultrasound probe position and orientation estimation result is determined by the flowchart illustrated in FIG. 3. Then, the position and orientation of the ultrasound probe at the time point are stored in the memory 7. In FIG. 3 and subsequent figures that describe a process flow in the same manner, the letter “S” represents “step”.

The position and orientation estimation flow illustrated in FIG. 3 is initiated when the start of an examination or release from examination freeze is entered from the control panel 5 by a user.

In step S201, the image acquisition function 6b serving as an acquisition unit acquires the exterior image (image data) including the ultrasound probe 2 from the camera 3 via the communication interface of the camera control circuit 14. Since the angle of view of the camera 3 has been adjusted to include a subject in the previous step, the image may be captured without angle-of-view adjustment. However, at least one of pan control, tilt control, zoom control, and the like may be performed to set the angle of view so that the ultrasound probe 2 may be more easily detected.

### One or More Embodiments of Virtual Feature Points on an Ultrasound Probe

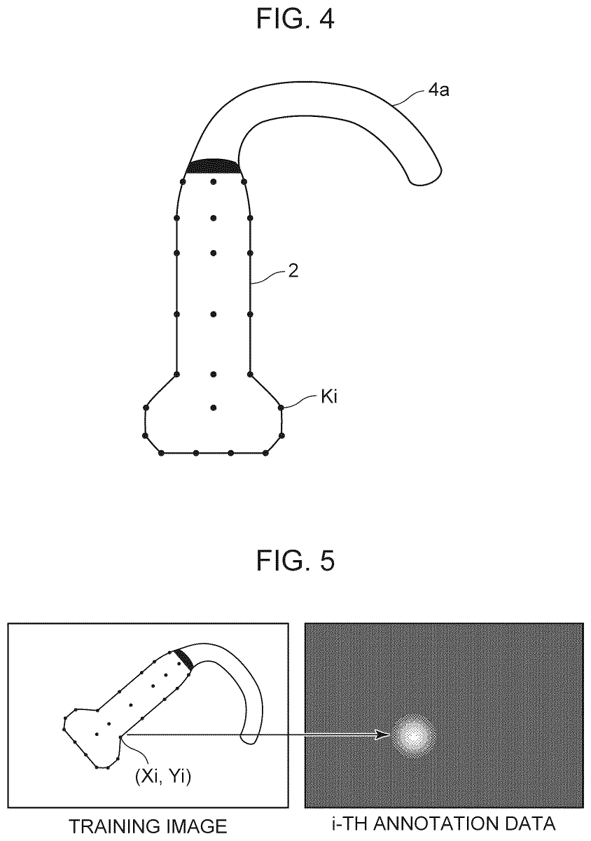

FIG. 4 illustrates at least one embodiment example of an exterior appearance of the ultrasound probe 2 and a cable 4a that connects the ultrasonic diagnostic apparatus main body 1 to the ultrasound probe 2 and virtual feature points K set in advance at any positions on the ultrasound probe 2. A plurality of black dots drawn on the ultrasound probe 2 represent a plurality of virtual feature points K (K1, K2, . . . KN) (N is the total number of feature points that are set). Information regarding the virtual feature points K is stored in the nonvolatile memory 8. The information regarding the virtual feature points K herein is the three-dimensional coordinate information (Xi, Yi, Zi) (i=1, 2, . . . N) of each of the individual virtual feature points K (K1, K2, . . . KN) with respect to an appropriately determined three-dimensional coordinate origin (0, 0, 0).

### One or More Embodiments of a Deep Learning Model

In step S202, a coordinate estimation process (a position estimation process) is performed to estimate the coordinates of any one of the virtual feature points set on the ultrasound probe by using the input image. The estimation of the coordinates of each of the feature points is performed using a pre-trained deep learning model that outputs a two-dimensional array, such as an autoencoder.

### One or More Embodiments of Training Data

Training data are necessary to train a deep learning model. As used herein, the term “training data” refers to training image data each containing the captured image of the ultrasound probe 2 and the annotation data indicating the coordinates of the virtual feature point K in each image. To acquire the training image data and the annotation data, computer graphics (CG), for example, may be used. The use of CG allows for generation of a wide variety of training image data and accurate calculation of the coordinates of the virtual feature points K.

The training data may also be acquired by capturing the training image data of the ultrasound probe 2 with a camera and, at the same time, directly obtaining the position and orientation by attaching an AR marker to the ultrasound probe 2. Alternatively, the position and orientation may be obtained in advance through calculation by attaching, for example, an inertial sensor with built-in gyro sensor and acceleration sensor to the ultrasound probe 2.

The training image data is an array data including the captured image of the ultrasound probe 2 and having the size of H×W×C, where H is the height of the image, W is the width of the image, and C is the number of color channels (“1” for a grayscale image, and “3” for an RGB color image).

The annotation data used for training is, for example, an H×W×N array data when the size of the training image data is the one described above. The number N of channels is the total number of virtual feature points described above. That is, the annotation data is a set of N two-dimensional arrays each having the same height and width as the training image data (N is the total number of virtual feature points). The channels 1 to N of the annotation data represent the positions of the feature points K1 to KN, respectively. FIG. 5 illustrates at least one embodiment example of positions of the virtual feature points K in the training image data and the annotation data corresponding to the i-th feature point (the channel i (i=1 to N) of the annotation data). When the coordinates of the feature point Ki in the training image data are (Xi, Yi), the channel i of the annotation data is an array of concentrically attenuating numerical values (a heat map) with the peak at the coordinates (Xi, Yi). The heat map is a two-dimensional array with values each ranging from 0 to 1, where the peak value is 1, and the values at positions sufficiently distant from the peak are 0. That is, the annotation data is a set of such heat maps centered at the positions of the feature points Ki.

In terms of the height and width, the array size of annotation data may be changed to any size as long as the number of channels N is fixed. For example, by setting the annotation data array size to H/2, W/2, and N, the number of parameters of the deep learning model may be reduced as compared to the case where the height and width are the same as those of the training image data. As a result, the time required to train the model and the computation time during estimation may be reduced.

### One or More Embodiments of a Coordinate Estimation Process

In step S202, the camera image acquired in S201 is input to the deep learning model described above to estimate the coordinates of the feature points of the ultrasound probe 2. The output of the model is H×W×N array data, which is similar to the annotation data. The channel i (i=1 to N) is a heat map that represents the probability of the existence (0 to 1) of the feature point i. That is, the probability of the existence of a feature point at the coordinates of the feature point i increases with increasing value of the channel i. In step S203, the peak is detected from each of the channels using any one of existing techniques to estimate the coordinates of the virtual feature point K in the image.

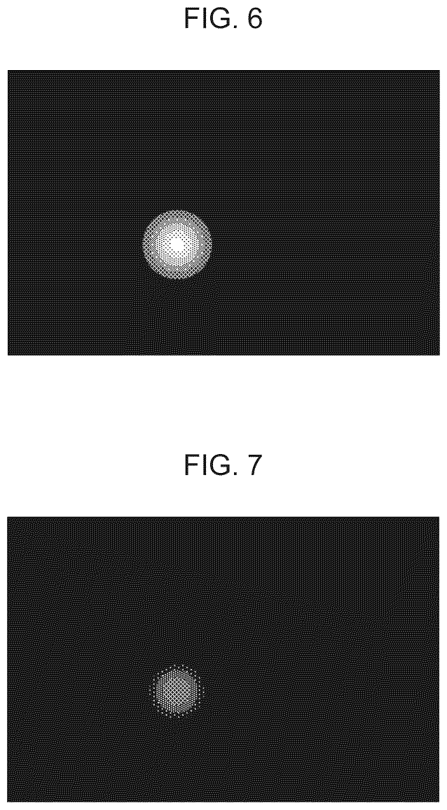

The coordinates of the feature points that may be estimated by peak detection are those of a subset of the N virtual feature points K. It may be difficult to estimate the coordinates of a feature point located behind an object or hidden by another object, such as the human hand, in the camera's view. FIGS. 6 and 7 illustrate one or more embodiment examples of heat maps of the feature points with high and low reliability, respectively. In the peak detection performed in step S202, a threshold value may be set to determine whether the value at the coordinates is the peak or not. For example, assume that the threshold value of the reliability for determining the peak is 0.4 and that, as a result of the peak detection, the values at the coordinates indicating the peak values are 0.9 in FIG. 6 and 0.3 in FIG. 7. Then, in the case illustrated in FIG. 6, the coordinates of the feature point having the index are estimated. However, in the case illustrated in FIG. 7, the coordinates of the feature point having the index are not estimated. That is, as described above, in step S202, the estimation function 6c serving as a position estimation unit calculates the reliability of a virtual feature point and estimates the coordinates on the basis of the reliability.

Hereafter, the virtual feature points K each located at a position estimated from the image are referred to as estimated feature points Pj (1≤j≤N), and let J be a set of the indices j of the estimated feature points. The coordinates of the plurality of virtual feature points K estimated in the coordinate estimation process (the estimated feature points Pj) are two-dimensional coordinates.

The coordinates of the feature points estimated in step S202 do not necessarily include the coordinates of all of the preset virtual feature points K in one or more embodiments. It may be difficult to estimate the coordinates of a feature point located behind an object or hidden by another object, such as the human hand, in the camera's view. To complement the coordinates of feature points that cannot be estimated, any inter-frame processing using the estimation results of past times may be included in the processing of step S203. For example, in a case where the coordinates of a feature point Ki at a certain time point t=t0 cannot be estimated, the coordinates of the feature point Ki may be estimated by using the coordinates at a time point t=t0−1. Alternatively, filtering, such as the Kalman filter, may be performed using the statistics of the coordinate values from t=0 (the camera image acquisition start time) to t=t0−1 and the physical model. In this way, the coordinates of at least a subset of the plurality of virtual feature points K on the image are identified in step S202.

The image used for coordinate estimation in step S202 may be the camera image captured in S201 or may be the camera image subjected to any image processing, such as edge enhancement or noise reduction filtering. It is also possible to select an ROI including the ultrasound probe from the camera image. At this time, the ROI may be manually selected from the image by an operator using the control panel 5 or the touch panel function provided in the display 4. Alternatively, a region containing an ultrasound probe is detected through image processing, and the ROI may be determined adaptively for a frame at each time point. Image processing here may be based on existing technique, such as template matching using known image features, or any object detection technique using deep learning. When the coordinate estimation process in step S202 and the feature point coordinate identification process in step S203 are performed, the processing circuit 6 functions as a position estimation unit. That is, in one or more embodiments, the above-described processing is processing performed by the position estimation unit to estimate the positions of a plurality of virtual feature points set in advance on the surface of the ultrasound probe 2 serving as the examination device on the basis of the images acquired by the image acquisition function 6b serving as the acquisition unit.

### One or More Embodiments of Identification of Coordinates by Threshold Processing

In step S204, a determination is made whether the number of feature points having coordinates identified in step S202 is greater than or equal to a preset threshold value Th. In a case where the number of feature points having coordinates identified in step S202 is greater than or equal to the preset threshold value Th, the processing proceeds to step S205.

In the feature point matching performed in step S205 described below, the position and orientation of the ultrasound probe 2 relative to the position of the camera 3 are estimated. In one or more embodiments, in the estimation of the position and orientation of the ultrasound probe 2, the coordinates of estimated feature point Pj estimated in S202 and the three-dimensional coordinate information (Xi, Yi, Zi) of each of the virtual feature points K (K1, K2, . . . KN) are used. At this time, the threshold value Th may be defined as the minimum number of feature points required to solve a problem according to the position-orientation identification problem setting. To make the position and orientation estimation more robust, the number may be set to be greater than the minimum number required. In a case where the number of feature points having coordinates identified in step S202 is less than the preset threshold value Th, step S205 is skipped, and the inter-frame correction process is performed in step S206 using the information at the previous time point.

### One or More Embodiments of an Orientation Estimation Process

In step S205, at least one embodiment of the orientation estimation process (an orientation estimation step) is performed to estimate the position and orientation of the ultrasound probe 2 relative to the position of the camera 3 in three-dimensional coordinates. The coordinates of the estimated feature points Pj (1≤j≤N) estimated in S202 and the three-dimensional coordinate information (Xi, Yi, Zi) of each of the virtual feature points K (K1, K2, . . . KN) are used in the orientation estimation process (the orientation estimation step). The coordinate Information (Xi, Yi, Zi) of the virtual feature points K that correspond to the indices J of the feature points having the estimated coordinates is first read into the work memory. The position and orientation of the ultrasound probe 2 may be estimated by solving the Perspective-n-Point problem (PnP problem) to obtain the external parameters (the rotation vector and translation vector) of the camera. Simultaneously, a more advanced algorithm related to the PnP problem or an algorithm that excludes outliers, such as the Random Sample Consensus (RANSAC), may be used. When the orientation estimation process is performed, the processing circuit 6 functions as an orientation estimation unit.

In step S206, the position and orientation are identified. Identifying the position and orientation is equivalent to obtaining the rotation vector and translation vector described above. That is, in step S206, the rotation vector and the translation vector estimated by performing the feature point matching in step S205 may be directly used.

In step S206, any type of inter-frame correction process may be also applied.

As described above, in a case where, in step S204, the number of feature points is less than the preset threshold value Th, the inter-frame correction process is performed using the information at the previous time point. In a case where the estimated position and orientation have changed significantly as compared to the position and orientation estimated at the previous time point, the estimation result at this time point may be discarded, and the position and orientation information at the previous time point may be applied. It is also possible to perform filtering, such as the Kalman filter, using statistical information regarding the position and orientation from t=0 (the camera image acquisition start time) to t=t0−1 and a physical model.

In step S207, a determination is made whether to terminate the position and orientation estimation of the ultrasound probe 2 on the basis of a user instruction. In a case where the process is not terminated, an image is again acquired from the camera 3 at the next time point, and a new position and orientation estimation is performed based on the acquired image. In one or more embodiments, the position and orientation estimation is terminated in a case where the user inputs an end-of-examination instruction, an examination freeze instruction, or the like from the control panel 5. The position and orientation estimation process described above is also referred to as an orientation estimation step. That is, the position and orientation estimation process is the process of estimating the orientation of the examination device by using the orientation estimation unit on the basis of the positions of a plurality of virtual feature points estimated by the position estimation unit.

In general, the user grasps the ultrasound probe 2 by hand to perform an examination. For this reason, the entire image of the ultrasound probe 2 is not captured by the camera during examination, and part of the ultrasound probe 2 is hidden by the user's hand, that is, so-called occlusion occurs at all times. When the position and orientation of the ultrasound probe 2 are detected from the camera image, such an occlusion issue has been a major issue. However, according to one or more embodiment examples of the present disclosure, the technique for obtaining the position and orientation by feature point matching is employed, and, thus, the position and orientation may be detected as long as the number of estimated feature points P does not fall below the threshold value Th in step S204.

As described above, according to one or more embodiments, the image acquisition function 6b acquires an image including the ultrasound probe 2 during examination. The estimation function 6c acquires the coordinates of at least a subset of the virtual feature points preset on the ultrasound probe on the basis of the image and estimates the position and orientation of the ultrasound probe 2 by matching the acquired coordinates with the three-dimensional coordinates of the virtual feature points. Therefore, the ultrasonic diagnostic apparatus 100 according to one or more embodiments may provide a robust technique against occlusion and may accurately estimate the orientation of the examination device without providing a sensor in the examination device.

### Modification 1 that May be Used in One or More Embodiments

### One or More Embodiments of Identification of Scan Direction Using Orientation Mark

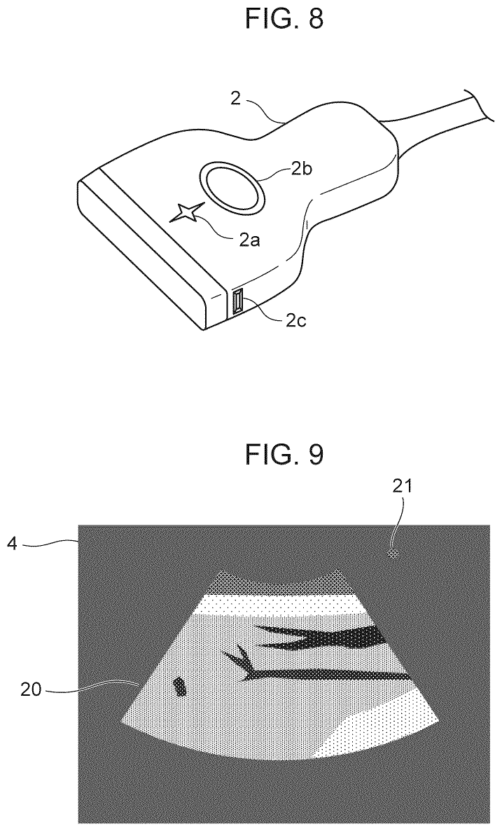

In general, the vertical display direction and the horizontal display direction of an image in the image display method during ultrasonic examination are predetermined so that the user may see the most natural view during the examination. Therefore, the user grasps the ultrasound probe 2 in the predetermined orientation and scans the body of a subject. As illustrated in FIG. 8, at least one embodiment example that may be used for the ultrasound probe 2 has, thereon, a logo mark 2a indicating the brand, an operation button 2b for switching between start and stop of image capturing at user's fingertips, and an orientation mark 2c indicating the direction by a protrusion. These marks allow the user to determine the correct orientation of the ultrasound probe 2.

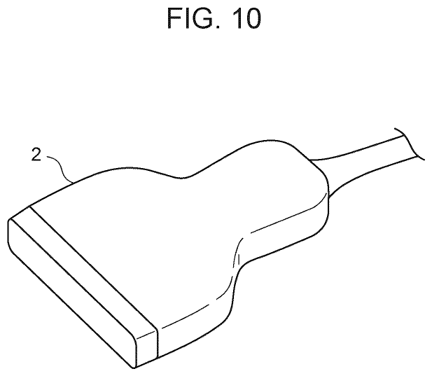

FIG. 9 illustrates an example of an acquired diagnostic ultrasound image 20 displayed on the display 4. A guide mark 21 is displayed on the screen. The user scans using the ultrasound probe 2 so that the orientation of the orientation mark 2c and the orientation of the guide mark 21 match and stores the diagnostic ultrasound image 20. The marks on the ultrasound probe 2, such as the logo mark 2a, the guide mark 21, and the orientation mark 2c, are also referred to as landmarks.

However, a user who is unfamiliar with the examination may perform the examination with the ultrasound probe 2 facing a wrong direction, resulting in saving a horizontally flipped image.

FIG. 10 is a view of the ultrasound probe 2 in FIG. 8 as viewed from the side without the logo mark 2a and the operation button 2b. As can be seen from FIGS. 8 and 10, the ultrasound probe 2 has a substantially symmetrical shape. Therefore, let the surface in FIG. 8 be a front surface, and the surface in FIG. 10 be a back surface for one or more embodiments. Then, in a case where the position and orientation of the ultrasound probe 2 are obtained from the image captured by the camera 3, the indexes of feature points on the back surface may be incorrectly regarded as those on the front surface, causing incorrect estimation.

According to one or more embodiments, the virtual feature points K are set in advance at any positions on the ultrasound probe 2. However, in one or more embodiments, the feature point of the ultrasound probe 2 may be set in a region with an asymmetrical property, such as the logo mark 2a, the operation button 2b, or the orientation mark 2c. In the peak detection process performed in step S202 illustrated in FIG. 3, the estimation function 6c may determine whether the coordinates of a feature point with asymmetrical property are detected from the heat map and, thus, may determine whether the other feature points that have front-back symmetry are located on the front side or the back side. This process may make the position and orientation estimation of the ultrasound probe 2 more robust.

### Modification 2 that May be Used in One or More Embodiments

### One or More Embodiments of Switching of Deep Learning Model for Plurality of Probes

As described above, the ultrasound probe 2 may be of any type, such as a sector ultrasound probe, a linear ultrasound probe, or a convex ultrasound probe. These types are used differently depending on the purpose of the examination, and each has different frequency characteristics and a different shape of the ground contact face to come into contact with the body surface.

The ultrasonic diagnostic apparatus 100 may include a plurality of ultrasound probes 2 of these types. In such a case, it is desirable for the estimation function 6c to have a deep learning model and three-dimensional coordinate information used by the coordinate estimation unit (position estimation unit) and the position orientation estimation unit (orientation estimation unit) for each of the ultrasound probes 2 having different shapes. That is, in one or more embodiments, the virtual feature points K are set for each of the different ultrasound probes 2, and images and annotation data for training are generated. Then, the deep learning model and the three-dimensional coordinate information of the virtual feature points trained for each of the ultrasound probes are stored in the nonvolatile memory 8.

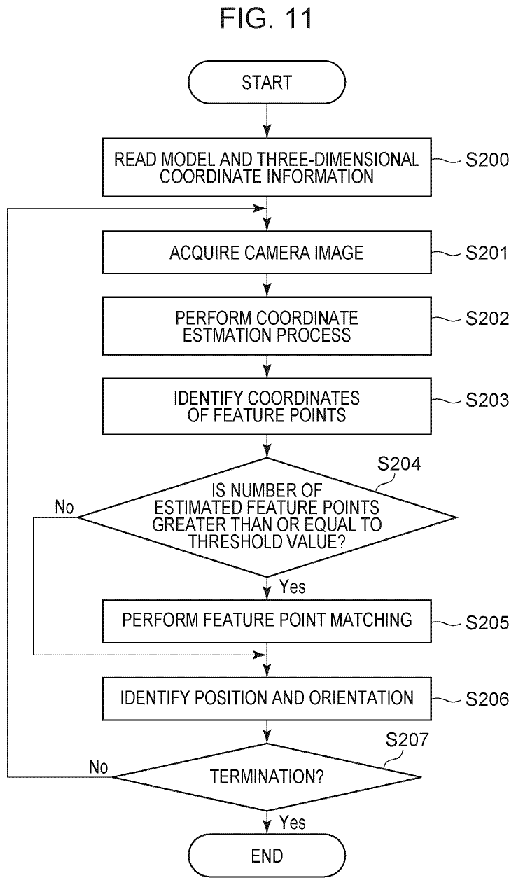

FIG. 11 is a flowchart of at least one embodiment of a process according to Modification 2 that may be used in one or more embodiments. Unlike the flowchart illustrated in FIG. 3, step S200 is added to the flowchart. As illustrated in FIG. 11, the estimation function 6c reads the model and the three-dimensional coordinate information used to perform the position and orientation estimation in step S200 according to the selected type of ultrasound probe 2.

In step S200, the user may select the deep learning model and the three-dimensional coordinate information of the virtual feature points. When starting a new examination, the user selects the ultrasound probe 2 to be used for the purpose of the examination by using the control panel 5. Thereafter, the estimation function 6c reads out the model and the three-dimensional coordinate information corresponding to the ultrasound probe 2 selected by the user to perform the position and orientation estimation.

Alternatively, to read the deep learning model and the three-dimensional coordinate information of the virtual feature points, the type of ultrasound probe 2 may be automatically selected by identifying the ultrasound probe 2 from the camera image in step S200. For example, object detection using deep learning may be used to identify the ultrasound probe 2 from the camera image. More specifically, a model may be used that has learned the exterior appearances of the plurality types of ultrasound probes 2 by using a deep neural network that detects an object from an image, such as SSD (Single Shot Multibox Detector) or YOLO (You Only Look Once). The trained model, such as SSD and YOLO described above, is prestored in the nonvolatile memory 8 serving as the storage medium.

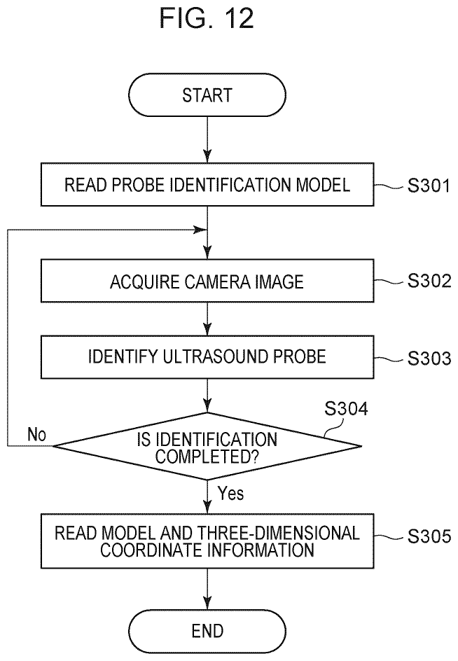

A flowchart for at least one embodiment of automatically identifying the type of ultrasound probe 2 by a deep learning model in step S200 is illustrated in FIG. 12. In step S301, the estimation function 6c first loads a deep learning model for identifying the type of ultrasound probe 2 from the nonvolatile memory 8 into the work memory. Subsequently, in step S302, the image acquisition function 6b acquires a camera image. In step S303, the acquired camera image is used as an input to perform an object detection process for detecting the ultrasound probe 2 using the deep learning model. Thus, it is identified which type of ultrasound probe 2 is captured in the camera image. In step S304, it is determined whether the identification of the ultrasound probe 2 in the camera image is complete. In a case where the identification is complete, the model and three-dimensional coordinate information used for position and orientation estimation of the ultrasound probe 2 are read out in step S305, and the processing ends. In a case where the identification is not complete, the processing returns to step S302 again to acquire the camera image at the next time point.

As described above, according to one or more embodiments, the ultrasonic diagnostic apparatus 100 may have different deep learning models and three-dimensional coordinate information of virtual feature points that differ from type to type of ultrasound probe 2. That is, the ultrasonic diagnostic apparatus main body 1 (the information processing apparatus) includes a plurality of types of the position estimation units and orientation estimation units, each corresponding to one type of ultrasound probe 2 (examination device). This enables estimation of the position and orientation of the ultrasound probe 2 even in a case where the user uses different types of ultrasound probes 2 depending on the purpose of the examination.

According to the present disclosure, the orientation of an examination device may be accurately estimated without installing a sensor in the examination device.

While the present disclosure has been described with reference to one or more embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-130995, filed Aug. 7, 2024, which is hereby incorporated by reference herein in its entirety.

What is claimed is:

1. An information processing apparatus comprising:
an acquisition unit that operates to acquire a captured image of an examination device;
a position estimation unit that operates to estimate positions of a plurality of virtual feature points preset on a surface of the examination device based on the image acquired by the acquisition unit; and
an orientation estimation unit that operates to estimate an orientation of the examination device based on the positions of the plurality of virtual feature points estimated by the position estimation unit.

2. The information processing apparatus according to claim 1, wherein the position estimation unit further operates to estimate coordinates of the plurality of virtual feature points.

3. The information processing apparatus according to claim 2, wherein the coordinates of the plurality of virtual feature points are two-dimensional coordinates in the image, and
wherein the orientation estimation unit further operates to estimate three-dimensional coordinates of the examination device using the two-dimensional coordinates in the image and estimate the orientation of the examination device.

4. The information processing apparatus according to claim 2, wherein the position estimation unit estimates the coordinates of at least a subset of the plurality of virtual feature points preset on the surface of the examination device.

5. The information processing apparatus according to claim 4, wherein the position estimation unit further operates to calculate reliability of the virtual feature points based on the image and to estimate the coordinates based on the reliability.

6. The information processing apparatus according to claim 5, wherein the position estimation unit further operates to exclude any of the virtual feature points with a reliability lower than a preset threshold value and to estimate the coordinates of the virtual feature points that are not excluded.

7. The information processing apparatus according to claim 1, wherein the plurality of virtual feature points include a virtual feature point that is set as a landmark of the examination device.

8. The information processing apparatus according to claim 7, wherein the landmark indicates information about a direction in which the examination device operates or is caused to scan.

9. The information processing apparatus according to claim 1, wherein each of the position estimation unit and the orientation estimation unit is provided in a plurality so as to have a different type that corresponds to one of a plurality of different types of the examination devices.

10. The information processing apparatus according to claim 1, wherein the orientation estimation unit further operates to estimate the position of the examination device relative to an image capture unit that captures the image of the examination device.

11. A medical diagnostic imaging apparatus comprising:
an examination device; and
the information processing apparatus according to claim 1.

12. The information processing apparatus according to claim 1, wherein the image is a moving image.

13. The information processing apparatus according to claim 1, wherein the examination device is an ultrasound probe.

14. An information processing method comprising:
acquiring a captured image of an examination device;
estimating positions of a plurality of virtual feature points preset on a surface of the examination device based on the acquired image; and
estimating orientation of the examination device based on the estimated positions of the plurality of virtual feature points.

15. A non-transitory computer-readable storage medium storing one or more programs including executable instructions that, when executed by a computer, cause the computer to perform the information processing method according to claim 14.
